(19) United States
(12) Patent Application Publication
(10) Pub. No.: US 2015/0006410 A1
(43) Pub. Date: Jan. 1, 2015

(54) METHOD AND SYSTEM FOR ELECTRONIC PATENT REVIEW AND ANALYSIS

(71) Applicant: Fatih Mehmet Ozluturk, Port Washington, NY (US)

(72) Inventor: Fatih Mehmet Ozluturk, Port Washington, NY (US)

(21) Appl. No.: 14/315,831

(22) Filed: Jun. 26, 2014

Related U.S. Application Data
(60) Provisional application No. 61/839,705, filed on Jun. 26, 2013.

(51) Int. Cl. G06Q 50/18

(52) U.S. Cl. CPC G06Q 50/184
USPC 705/310

(57) ABSTRACT

Systems and methods are disclosed regarding a platform for intuitive, easy and quick searching, analysis, and reporting of patents, patent applications and references. These features may be done on a computing device. The platform may include a user-facing front end software application for interfacing with the user; a back-end processing part that stores, calculates, and outputs data for presenting to the user; and a mid-tier part that facilitates the communication between the front-end and back-end, and dynamically changes the data. The platform may obtain primary patent information about the patents and calculate secondary information based on the primary information. The platform may use parameters based on the primary and secondary information. The user may select parameters and weights to apply to the parameters. The platform may calculate a TrueValue score based upon the parameters and weights. The platform may also include a function for reading in, extracting and storing data.

This application claims the benefit of U.S. Provisional Application No. 61/839,705 filed Jun. 26, 2013, which is incorporated by reference as if fully set forth.

### FIELD OF INVENTION

The disclosed embodiments are generally directed to methods and systems for formatting, reviewing, analyzing, storing and outputting primary and secondary data and documents. More specifically, the disclosed embodiments are directed to formatting, analyzing, storing and outputting data and documents concerning patents, patent applications, references and information related patents and patent applications.

### BACKGROUND

Patents and patent applications are not only legal instruments to protect intellectual property rights but are also becoming a new asset class. Companies and individuals are acquiring or selling patents and patent applications to generate cash, to bolster their strategic position, to deter competitors, or to keep patents from being acquired by others. This is creating an increasingly active marketplace for these assets. As traded assets, patents and patent applications are not much different than fine art, real estate, or similar property. There are buyers, sellers, evaluators, financers, lawyers, brokers, and marketers in the patent marketplace who may review, analyze and evaluate patents and patent applications.

In reviewing a patent or a patent application, a typical reviewer looks at various sections of the document, such as the title; bibliographic information including the inventors, assignee, and filing, publishing, and issue dates; references cited and forward citations; U.S. and international class that the patent belongs to; abstract, summary, and detailed description; claims; and other sections. In addition, figures, tables, and lists included in a patent or application are very important in explaining and interpreting the text. Most of the time, the figures and the explaining text need to be reviewed together to understand the descriptions.

### SUMMARY

Systems and methods are disclosed to make the searching, review, evaluation, analysis, and reporting of patents, patent applications and references more intuitive, quicker, and easier than ever. These features may be done on a computing device such as a computer, tablet personal computer, smartphone or other similar electronic device. The system and method include a user-oriented front end software application for interfacing with the user and for communicating with the other functions of the system; a back-end processing part that stores, processes, formats, calculates, and outputs data for presenting to the user; and a mid-tier part that facilitates the communication between the front-end and back-end, and formats, translates, and dynamically changes the data. The system and method also include a loading function and downloading function for reading in, extracting, formatting, storing data, and for selecting, formatting, and outputting data, respectively.

The features of the system and method include the following, as well as the derivations and combinations of these features. A search interface includes a Basic Search option and an Advanced Search option. The Basic Search option triggers a full text search of the terms entered across all patent documents to find the patents that fit the user query. The Advanced Search option triggers a search for patent documents with the criteria specified in multiple search fields, such as a combination of Title, Inventor, Issue Date, and others.

Features on the Results Page include the ability to select the fields to display about a patent, such as the Title, Inventor, Patent No., Publication No., and others. The information is presented in a table format where each of the columns are sortable in ascending or descending order. In addition, the user can change which columns are displayed. The Results Page includes pagination to allow easy access to subsequent pages of results, if the results do not fit on one page. In addition, the Results Page has a preview option where the user may view a preview of the patent showing the bibliographic information as well as the Title, Inventors, and Assignee. The purpose of the preview option is to provide the user with enough information for the user to decide whether to look at the patent in more detail before going to the Details Page. The user can select to preview individual patent documents on the Results Page or alternatively the user can see the preview panes for all patent documents.

The Details Page shows all the details of the patent document, including the information that is presented in the preview pane on the Results Page. On the Details Page, there are several very useful features. First, the user can review the patent text and patent figures side by side, giving the user the ability to read the associated text while viewing the relevant figure at the same time. This makes the reviewing of the patent intuitive, easy, and quick. An additional feature, the Menu on the Details Page, is responsive to the section of the patent being reviewed, and indicates that section. In other words, the user can click the section headings on the Menu to go to that section in the patent, and also, as the user scrolls up or down to different sections, the Menu responds by indicating the section that appears on the screen. This makes it easy to know and remember which section the user is reviewing. An additional important feature is search term highlighting. Accordingly, the user can enter a search term and have that term highlighted wherever it appears in the text being reviewed. This is very useful for the user who is looking for parts of the text related to a term. An additional feature is the figure-sensitive scrolling of the text. This feature automatically brings into view the figure that is being mentioned in the text. For instance, when the text description and the figures of the patent are shown side by side, if the user scrolls to a section of text that mentions Figure X, then the system displays Figure X automatically on the side. Alternatively, when the user is viewing Figure X, the text scrolls automatically to the instance of Figure X in the text. Either option is user selectable. This feature makes it very easy, quick, and intuitive to review associated text and figures together. In addition to the features described above, the user can scroll through the text and scroll through the figures independently also.

The system and method may read in, download, extract or otherwise obtain primary patent information, such information that can be directly extracted from a patent document. This primary patent information may be downloaded or extracted directly from patent office databases, such as the databases of the United States Patent and Trademark Office. The system and method may then calculate secondary patent information based on the primary patent information or other sources. The system and method may store, analyze, display and report on both primary patent information and secondary patent information as primary and secondary information fields, respectively.

The system and method has a number of features on the Analytics Page. This page in itself is a new concept in patent evaluation. The Analytics Page presents the user with a number of value indicators (or parameters) about a patent, patent application or reference. These value indicators or parameters include the length of claims, number of forward and backward citations, number of continuations, and numerous others. The system presents the value indicators or parameters that the user selects, and gives the user the ability to calculate a TrueValue for the patent based on the weights a user assigns to each selected value indicator or parameter. This is akin to an aggregate score card for the patent. The user may easily sort the patents in a large portfolio according to their TrueValue scores and identify the most promising patents. The user has the ability to select which value indicators or parameters to include in the calculation of TrueValue, as well as the individual weights of the selected value indicators or parameters in the final score. In sum, the analytics page is a unique way of giving the user specialized tools to evaluate patents.

### BRIEF DESCRIPTION OF THE DRAWINGS

FIG. 1 illustrates an example of a high level depiction of the relationship of the front-end, mid-tier, and back-end.

FIG. 2 illustrates an example computing device that may be used to implement features described herein as performed by the hardware (HW) platform.

FIG. 3 shows a tablet computer that is a more specific example of the computing device.

FIG. 4 illustrates an example Basic Search option where the user can enter one or more terms and search for them in the full text of patent documents.

FIG. 5 illustrates an example Advanced Search option where the user can enter one or more query terms in multiple fields and search for patents that satisfy the specific query.

FIG. 6 illustrates an example List View where the results are presented in a list, such as a table, showing the Patent Number and other fields selected by the user for displaying, such as the Title, Assignee, and others.

FIG. 7 illustrates an example Preview Pane displayed in a List View.

FIG. 8 illustrates an example Detailed Review Page highlighting the Abstract section.

FIG. 9 illustrates an example Detailed Review Page highlighting the Claims section.

FIG. 10 illustrates an example Detailed Review Page highlighting the Description section.

FIG. 11 illustrates an example implementation of the system using the secondary patent information in calculating TrueValue on the Analytics Page.

FIG. 12 illustrates an example Gallery View.

FIG. 13 illustrates the list of Tables in an example implementation.

FIG. 14 illustrates one example of a database table and associated fields, showing the fields (columns) of the table “uspto_patent_grant.”

FIGS. 15A-15B illustrate an example method of using the system to search for and display patents and patent related information.

FIG. 16 illustrates an example dialog box for TrueValue parameter setting.

FIG. 17 illustrates an example method of using the system to calculate a TrueValue index or score.

FIG. 18 illustrates an example method of the system calculating a TrueValue index or score.

FIG. 19 illustrates an example view of the Side Pocket contents.

FIG. 20 illustrates an example of the Save Window that opens up when the user clicks the Save command.

FIG. 21 illustrates an example of the Chart Window that opens up when the user clicks the Chart command.

### DETAILED DESCRIPTION OF EMBODIMENT(S)

In the descriptions herein, all descriptions and references apply equally to patents and patent applications. In general, the terms “patent” and “patent document” are used interchangeably to mean either or both of patents and patent applications. When the term “patent(s)” or “patent application(s)” is used alone without referring to the other, the other is not necessarily excluded, and any of these terms includes both patents and patent applications.

The methods and systems are implemented as a software (SW) program running on a hardware (HW) platform. The HW platform can be one or more of a specifically architected computer, server, data center, cloud computing platform, a generic personal computer, or any other computing platform capable of supporting the front-end, mid-tier, and back-end SW functions below. SW functions are described in more detail below. Also, one of ordinary skill in the art will appreciate that these functions can be split into different computers or servers, and what is implemented in SW versus in HW can be different in different implementations.

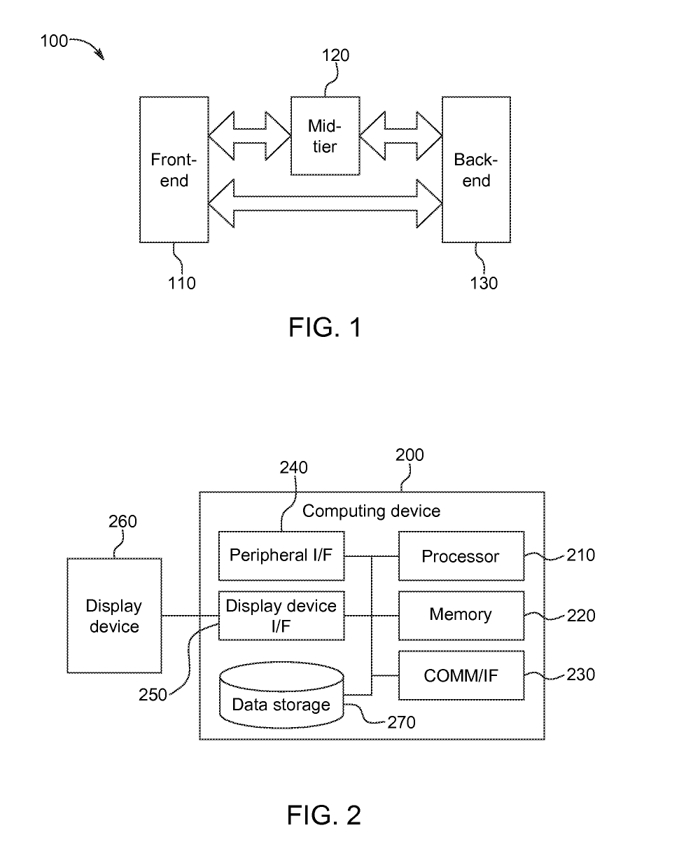

FIG. 1 illustrates an example of a high level depiction of the relationship of the front-end 110, mid-tier 120, and back-end 130 in the HW platform 100. In an example implementation, the front-end 110 resides in the user equipment, such as a desktop computer, laptop computer, tablet computer, smartphone, or similar device; the mid-tier 120 and the back-end 130 reside in one or more servers, and they communicate with the front-end 110 over a network, such as the Internet. The server may be a dedicated machine or it may be hosted in the cloud—for instance on AMAZON Cloud Service, or RACKSPACE, or other.

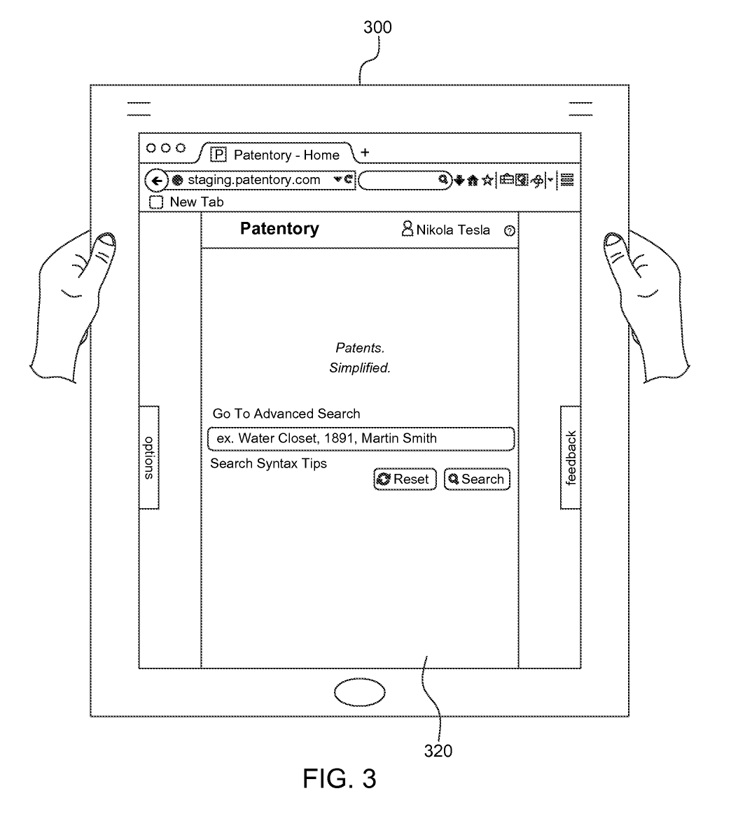

FIG. 2 illustrates an example computing device 200 that may be used to implement features described herein as performed by the HW platform. Accordingly, an instance of the computing device 200 may be used to implement features of front-end 110, mid-tier 120, and back-end 130. Further, an instance of the computing device 200 may be used to implement features of a server, desktop computer, laptop computer, tablet computer, smartphone, or similar device. The computing device 200 includes a processor 210, memory device 220, communication interface 230, peripheral device interface 240, display device interface 250, and data storage device 270. FIG. 2 also shows a display device 260, which may be coupled to or included within the computing device 200.

As used herein, the term “processor” refers to a device such as a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), a state machine, or a similar type of device.

The memory device 220 may be or include a device such as a Dynamic Random Access Memory (D-RAM), Static RAM (S-RAM), other RAM or a flash memory. Further, memory device 220 may be a device using a computer-readable medium. The data storage device 270 may be or include a hard disk, a magneto-optical medium, a solid-state drive (SSD), an optical medium such as a CD-ROM, a digital versatile disk (DVDs), or Blu-Ray disc (BD), or other type of device for electronic data storage. Further, data storage device 270 may be a device using a computer-readable medium. As used herein, the term “computer-readable medium” refers to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The communication interface 230 may be, for example, a communications port, a wired transceiver, a wireless transceiver, and/or a network card. The communication interface 230 may be capable of communicating using technologies such as Ethernet, fiber optics, microwave, xDSL (Digital Subscriber Line technologies), IEEE 802.11 technology, Wireless Local Area Network (WLAN) technology, wireless cellular technology, or any other appropriate technology.

The peripheral device interface 240 may be configured to communicate with one or more peripheral devices. The peripheral device interface 240 may operate using a technology such as Universal Serial Bus (USB), PS/2, Bluetooth, infrared, serial port, parallel port, FireWire and/or other appropriate technology. The peripheral device interface 240 may, for example, receive input data from an input device such as a keyboard, a mouse, a trackball, a touch screen, a touch pad, a stylus pad, or other device.

The display device interface 250 may be an interface configured to communicate data to display device 260. The display device 260 may be, for example, a monitor or television display, a plasma display, a liquid crystal display (LCD), or a display based on a technology such as front or rear projection, light emitting diodes (LEDs), organic light-emitting diodes (OLEDs), or Digital Light Processing (DLP). The display device interface 250 may operate using technology such as Video Graphics Array (VGA), Super VGA (S-VGA), Digital Visual Interface (DVI), High-Definition Multimedia Interface (HDMI), or other appropriate technology. The display device interface 250 may communicate display data from the processor 210 to the display device 260 for display by the display device 260. As shown in FIG. 2, the display device 260 may be external to the computing device 200, and coupled to the computing device 200 via the display device interface 250. Alternatively, the display device 260 may be included in the computing device 200.

An instance of the computing device 200 of FIG. 2 may be configured to perform any feature or any combination of features of the system and method described herein as performed by the front-end 110. Also, an instance of the computing device 200 of FIG. 2 may be configured to perform any feature or any combination of features described above as performed by the mid-tier 120. Further, an instance of the computing device 200 of FIG. 2 may be configured to perform any feature or any combination of features described above as performed by the back-end 130.

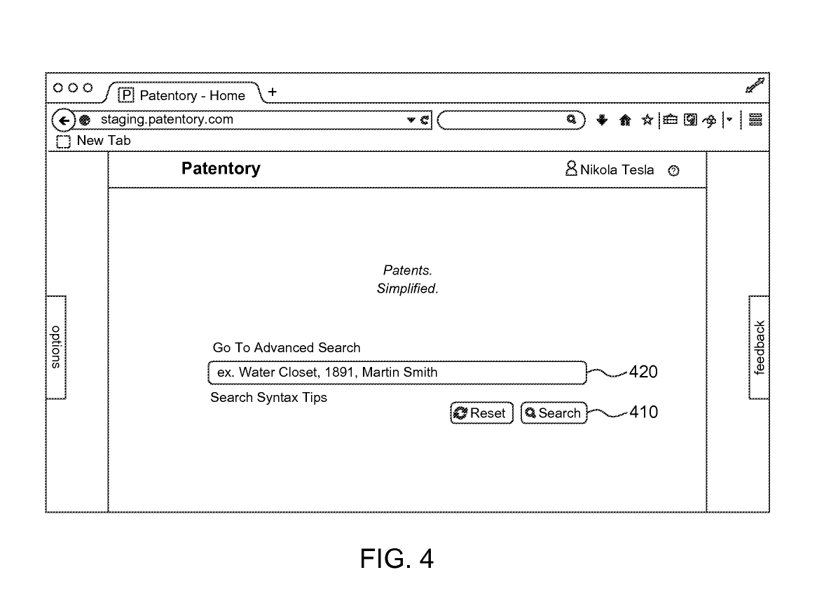

FIG. 3 shows a tablet computer 300 that is a more specific example of the computing device 200 of FIG. 2. The tablet computer 300 may include a processor (not depicted), memory device (not depicted), communication interface (not depicted), peripheral device interface (not depicted), display device interface (not depicted), storage device (not depicted), and touch screen display 320, which may possess characteristics of the processor 210, memory device 220, communication interface 230, peripheral device interface 240, display device interface 250, storage device 270, and display device 260, respectively, as described above with reference to FIG. 2. The touch screen display 320 may receive user input using technology such as, for example, resistive sensing technology, capacitive sensing technology, optical sensing technology, or any other appropriate touch-sensing technology.

The SW platform may use a network, such as the Internet, and related communications protocols and layers. The layers may include a physical layer, data layer, network layer, transport layer, session layer, presentation layer and application layer. The data layer, or another layer, may be configured to access data from a data source, including an external data source. The external data source may be a patent office, such the United States Patent and Trademark Office (USPTO). The external data source may also be located in GOOGLE storage, DROPBOX or a custom data source.

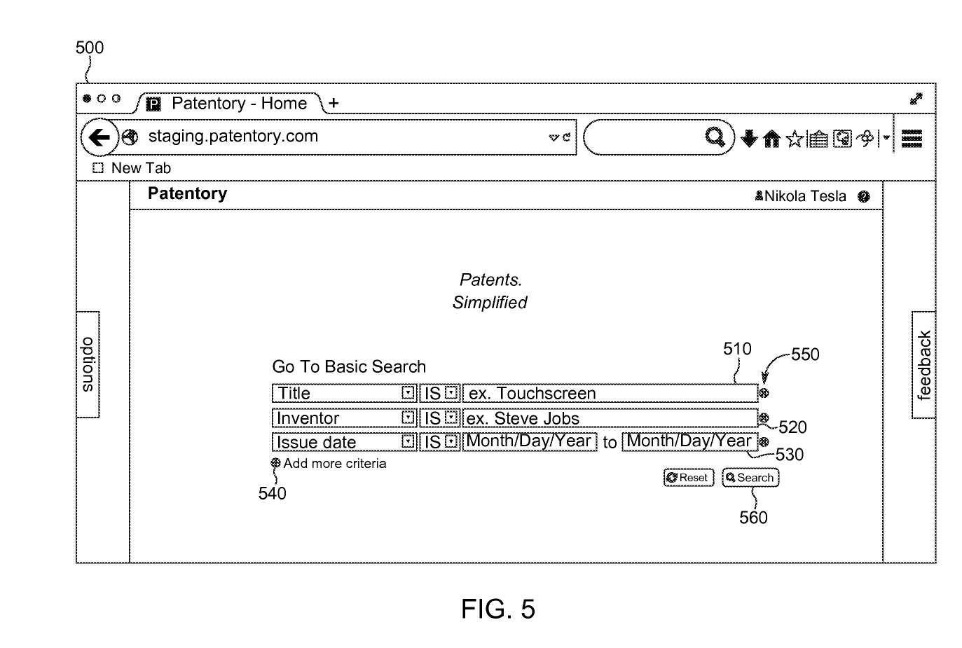

The front-end 110 is the user interface. An example implementation of the front-end uses HyperText Mark-up Language (HTML), Cascading Style Sheets (CSS), JavaScript, and other software languages and tools. The front end 110 is a series of pages presented to the user specifically designed to interact with the user, take input from the user, and present results to the user. In an example implementation, the front-end is a web based implementation. FIG. 4 through FIG. 12 show various pages and views of the front-end. In the examples shown, the front-end 110 is a browser based application, however it can be a standalone application also.

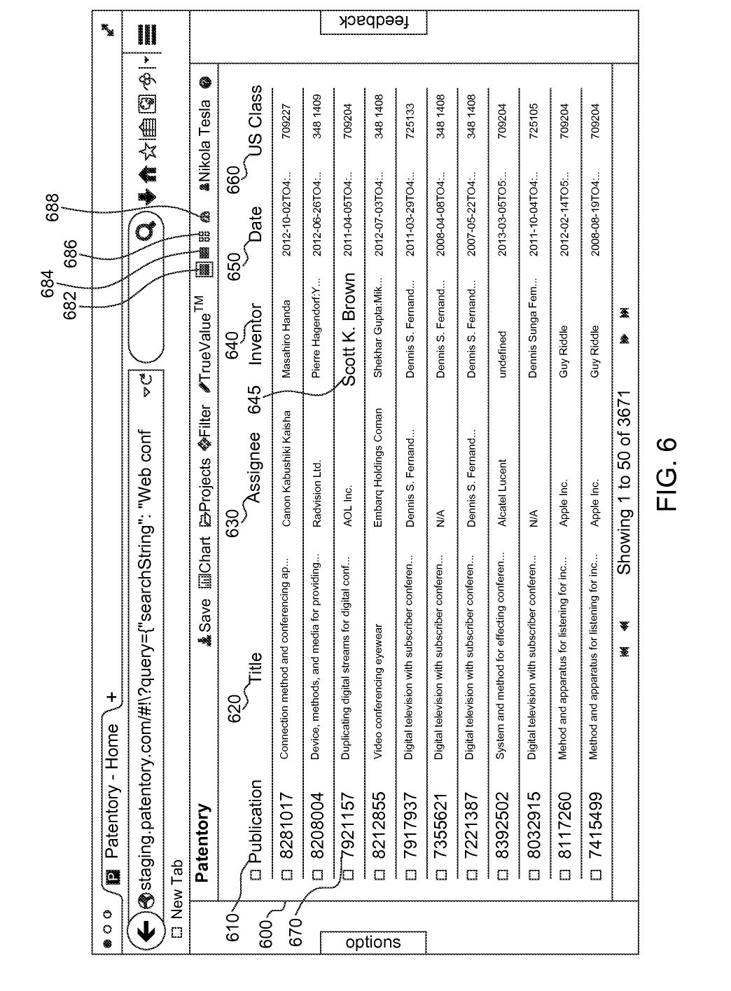

The front-end presents the user with a way to enter queries to search for patents, patent applications and references. Examples of the query interface are in FIG. 4 and FIG. 5. FIG. 4 illustrates an example Basic Search option where the user can enter one or more terms and search for them, by clicking on the “Search” button 410, in the full text of patent documents. FIG. 5 illustrates an example Advanced Search option where the user can enter one or more query terms in input boxes (510, 520 and 530) for multiple fields and search for patents that satisfy the specific query. For instance, an Advanced Search can query all patents that have the word “Touchscreen” in the Title 510, that have “Steve Jobs” as an Inventor 520 and that issued after a particular date 530. Other queries may be entered, such as a query for all patents that are assigned to Apple, Inc.

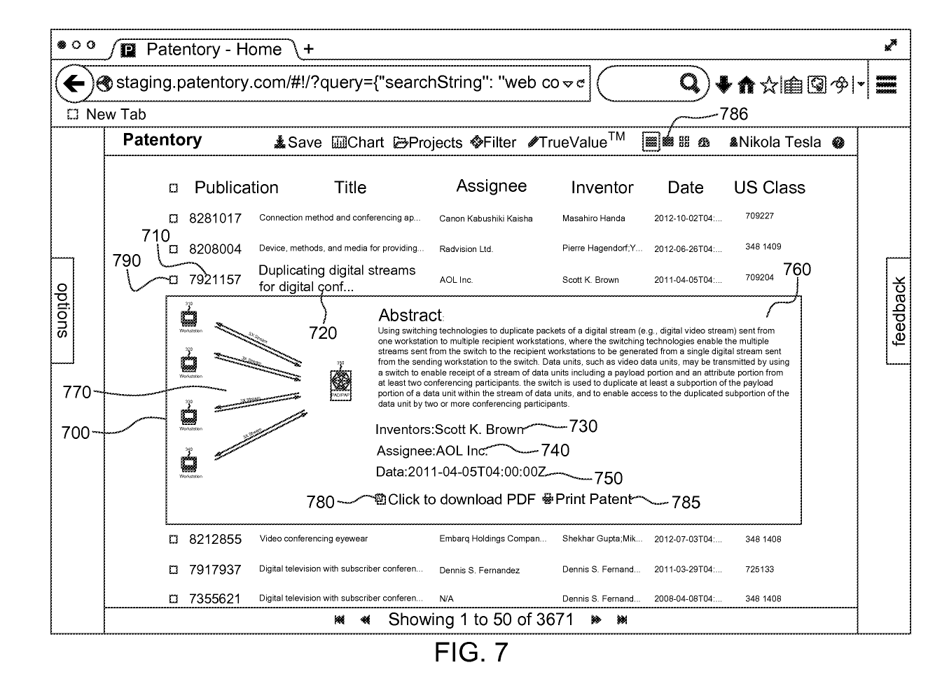

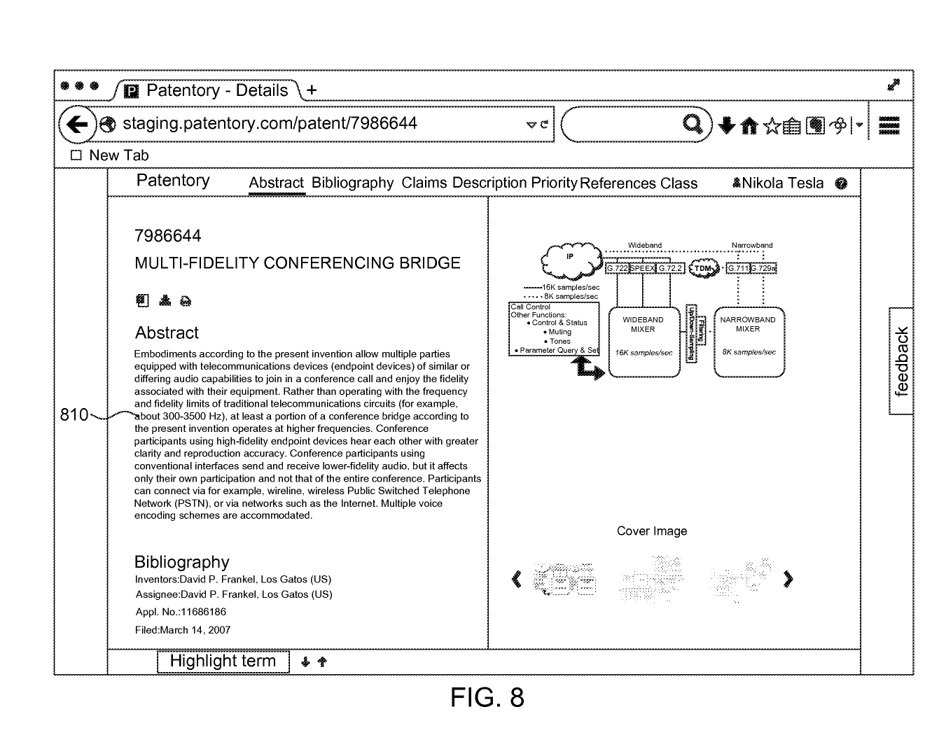

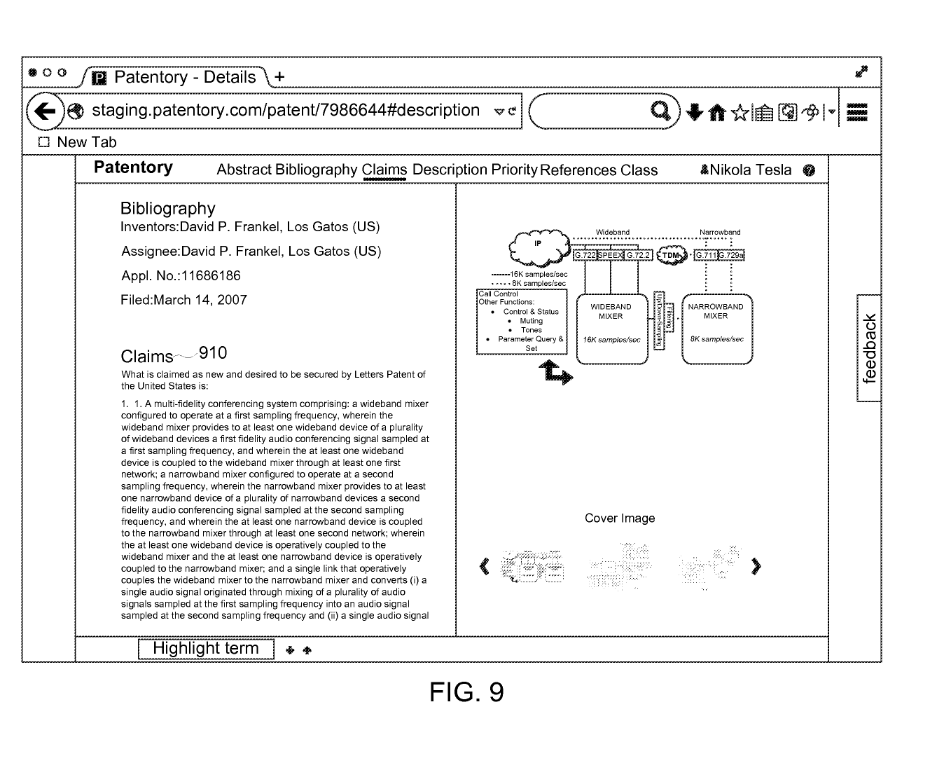

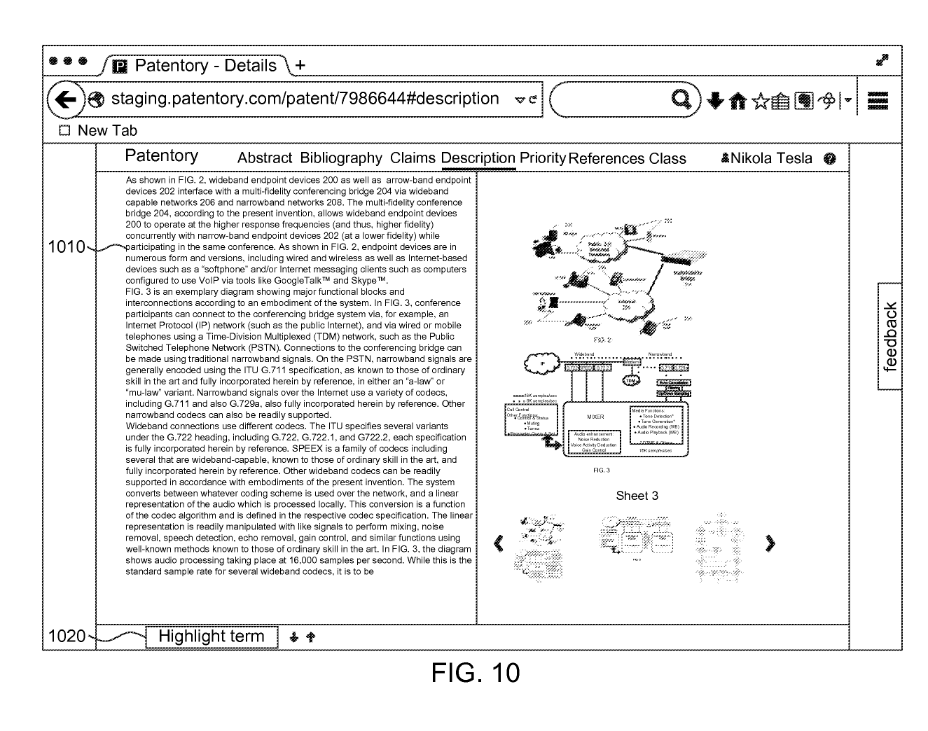

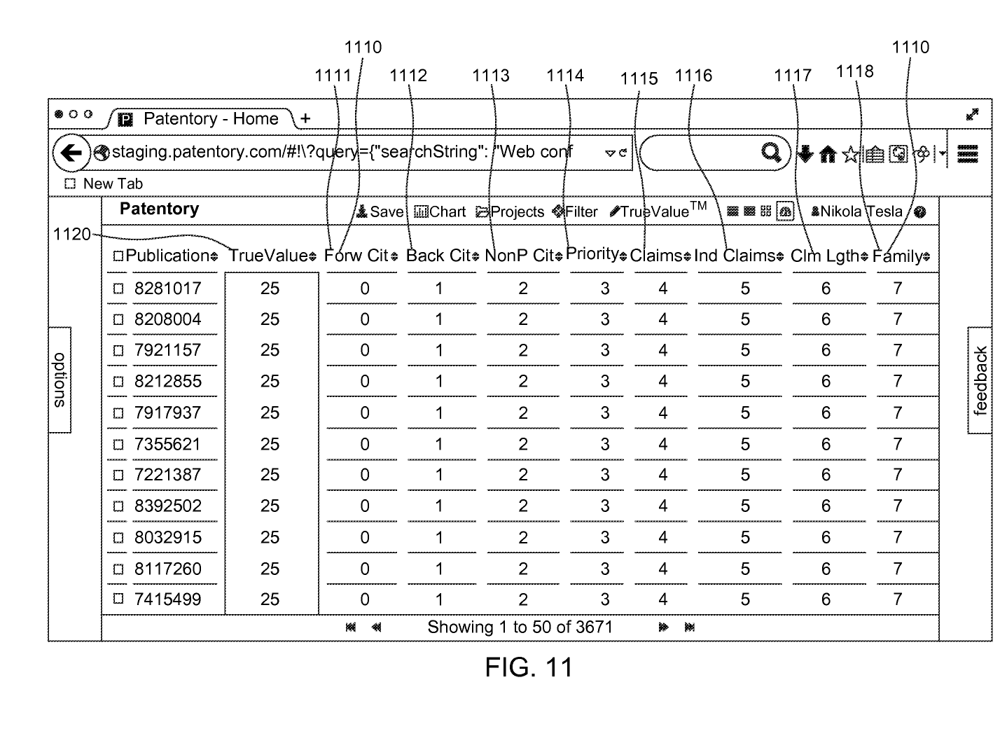

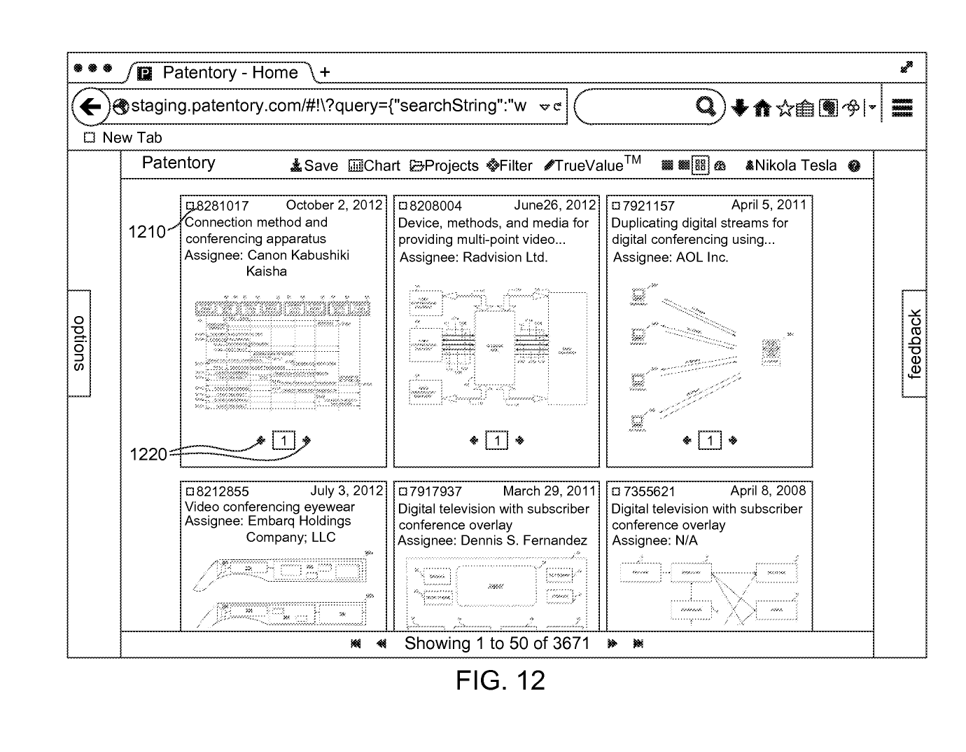

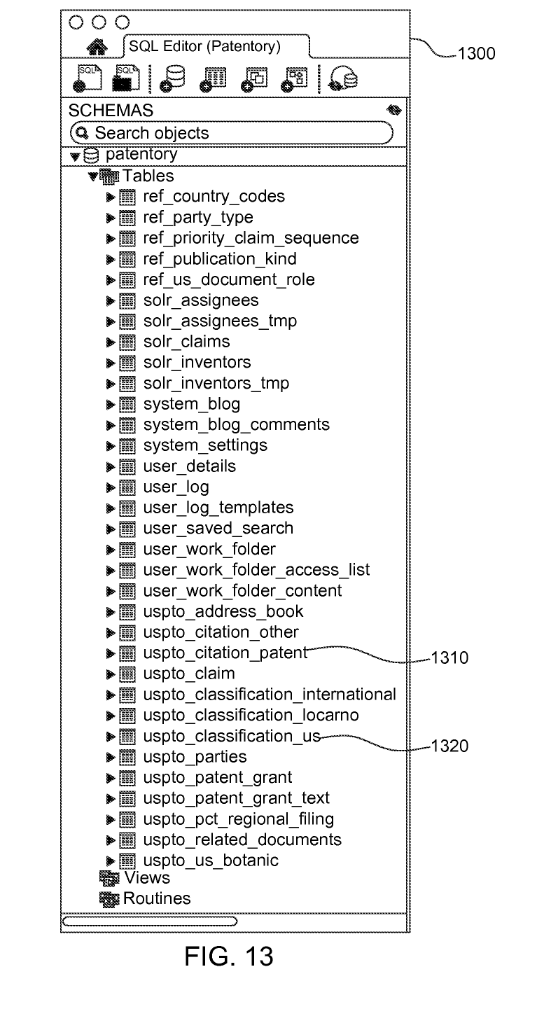

Other example functions of the front-end include displaying the results to the user, such as on the Results Page, shown in FIG. 6, FIG. 7 and FIG. 12. It also includes presenting the user with the patent review, as in Detailed Review Page shown in FIG. 8, FIG. 9 and FIG. 10. Other example functions of the front-end are to present the user with the analysis of the patents, such as shown in the Analytics Page, in FIG. 11.

In addition to receiving the user query and showing the results and analysis of the results, the front-end may also receive input from the user on other related functions such as saving, outputting, and printing the results, plotting charts, creating tables, and creating lists based on the query results. It may also receive inputs from the user for calculating TrueValue scores for patents. Another set of inputs the front-end may receive from the user are for selecting various outputs and saving them in the Side Pocket, a workspace where the user may save work product. All of these various types of inputs that the front-end receives from the user may be communicated to the mid-tier and to the back-end for further processing. Some user inputs are processed and acted upon within the front-end without requiring communication to the back-end.

The back-end is the part of the system that performs the storing and searching of patent documents, and extracting query results for presentation to the mid-tier and the front-end subsequently. Storing of the patent documents by the back-end may be done using a database. The database may store all the relevant and useful information in patents for subsequent searching and presenting to the front-end. The database may be a relational database system (RDBS), a document-oriented database system, a graph database, a hypermedia database, or any other type of database that is capable of storing patent information, performing queries, and presenting results. Moreover, the database may be implemented in a standalone computer, it may be a distributed database across multiple computers, or it may be a cloud based database, among other options. Implementation and type of the database can be selected from all possible options as long as it is capable of storing, querying, and presenting results on patent documents and data.

In addition to the patent document data stored in a database, the back-end may also store media content such as the patent figures, tables, DNA sequences, photographic images, and other patent data content in a file system. The file system may serve the media files for presenting to the user in the front-end, and for outputting in output files. Another aspect of the file system may include storing copies of patent files themselves, for example in PDF format, for download by the user, or for online viewing. Note that the media files can also be stored in the database system mentioned in the previous paragraph. Storing and retrieving such files in the database may not be preferable since they are not typically searched, but they are mostly presented to the user as part of the query output. In one example implementation, such media files related to patents are stored in a file system. The file system may be on the same computer, or server, as the database, or it may be physically located on a separate computer or server.

In one example implementation, the system uses indexes to associate patents with the patent related information in the database and with the media files stored in the file system. Thereby, when a patent is found to satisfy the user query and is to be presented to the user, the system may identify where in the database the patent related information, such as bibliographic information, is stored as well as where the media files such as patent figures, tables, and the PDF copy of the patent itself are stored in the file system. By using the index, the system may present the user with the information requested regardless of where and how it is stored. In an example implementation, the system uses the patent document number as the unique index. In other example implementations, however, any other index that can identify the information and the files to be served uniquely can be used as well.

The back-end may also store “secondary” information about the patent documents, for example such as the number of claims, length of claims, forward citations, backward citations, and other information. These secondary data fields are generally not displayed on a patent but may be calculated. For instance, the length of claims are calculated by performing a word count on the claims; the forward citations list is constituted by updating this list in the database as new patents issue that cite this patent as a reference; the backward citations list is read from the references list on the patent; and other fields are calculated in a similar manner. A representative list of secondary patent information that the back-end stores and serves is shown in Table 1. The list in Table 1 is an example list and not intended to be exhaustive; secondary patent information can include any field that is a value indicator and can be used in calculating an analytic value score for the patent. FIG. 11 illustrates an example implementation of the system using the secondary patent information in calculating TrueValue on the Analytics Page.

TABLE 1
List of Secondary Patent Information for Analytics

| Field | Definition |
|---|---|
| Forward citations | Number of the patents that cited this |
| | patent |
| Backward citations | Number of patents that this patent cited |
| | as references |
| Non-patent citations | Number of citations other than patent |
| | citations that this patent referenced |
| Priority | Number of years it has been since the |
| | priority date |
| Claims | Number of claims including independent |
| | and dependent claims |
| Independent claims | Number of independent claims |
| Length of independent claims | Word count of the independent claims |
| Family size | Number of patents that share the same |
| | priority document |
| Continuations | Number of continuations filed from this |
| | patent |
| Inventors | Number of inventors |
| Prosecution | Number of years it took for the patent to |
| | issue from filing date to issue date |
| Legal disputes | List of legal disputes the patent was |
| | involved in—at least the indication of |
| | such dispute |
| Opposition | Any opposition, inter-parte proceedings, |
| | post-grant review requests, and others |
| Reexamination | Indication of whether the patent was |
| | reexamined |
| Key inventor | Whether the inventor(s) are prolific, have |
| | other valuable patents, key inventions |

In an example back-end implementation of the system, the system uses an RDBS to store patent information. The system may extract this information from the patent data files of patent offices, such as the patent data files that the USPTO makes available. Typically, the patent information is recorded in Extensible Markup Language (XML) format, in Text format, or similar format in the files that the USPTO makes available. The system uses a Parser to read in the data files, extract out the information that needs to be stored in data fields, and insert them into the patent database. The particular implementation of the Parser may vary as long as it serves to extract the data fields from the data files and inserts them into the appropriate fields in the database.

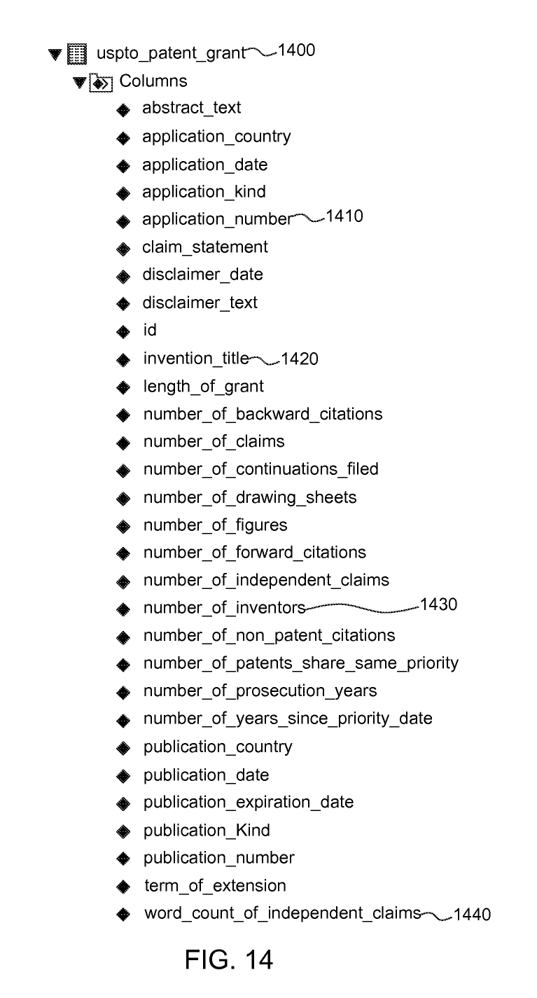

FIG. 13 illustrates the list of Tables 1300 in an example implementation. The system can be implemented using different tables as well. The names are self-explanatory in the tables; for instance, the table “uspto_citation_patent” 1310 holds the list of patent references cited by the patent, the table “uspto_classification_us” 1320 holds the U.S. Classification code for the patent.

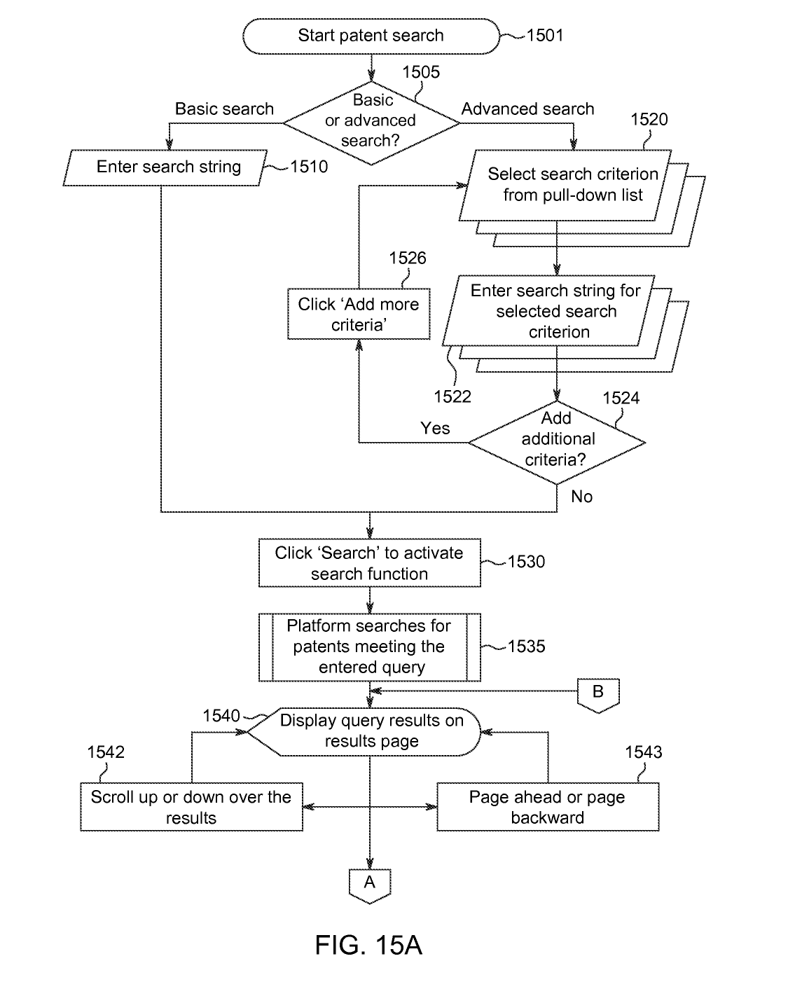

Each of the RDBS (or other database) tables hold one or more data fields and typically hold numerous data fields. FIG. 14 illustrates one example of a database table and associated fields, showing the fields (columns) of the table “uspto_patent_grant” 1400. In this figure, the field “application_number” 1410 holds the application number of the patent, “invention_title” 1420 holds the title of the patent, as an example. These two fields, and many others, are data fields which may be directly extracted from USPTO patent data files, and alternatively can be read from the patent itself. These fields may be considered primary data fields. Some other fields, such as “number_of_inventors” 1430 and “word_count_of_independent_claims” 1440 and many others, may be considered secondary data fields or secondary patent information that the system may calculate since they are not explicitly recorded in USPTO patent data files. In summary, the database system may store both primary patent information, such information that can be directly extracted from a patent document, and secondary patent information that the system calculates itself. The database may store the primary information in primary information fields and the secondary information in secondary information fields.

Separately from the RDBS, the system has a file system where the individual figures, tables and lists—such as amino acid sequences—of each patent and the PDF copy of the patent are stored. In an example implementation, the system may use a directory structure that is easily associated with the unique patent index. In this case the unique index is the patent number, such as U.S. Pat. No. 7,654,321, and the directory where all associated files are stored may have a structure such as: Server$> . . . 7/6/5/4/3/2/1/patent7654321.pdf.

In other words, the PDF copy of the file is in directory ‘1’, which is inside directory ‘2’ which is inside directory ‘3’ and so on. This makes it easy and quick for the back-end to find the files and serve them to the mid-tier and to the front-end.

As indicated above, the front-end system is a user interface and in an example system it is implemented as a series of web pages, viewable in a web browser, implemented in HTML, CSS, JavaScript, and other development tools. The back-end may be an RDBS and a file system implemented in a dedicated server, with the option to deploy them in a cloud server—such as the AMAZON cloud server or RACKSPACE cloud server. The mid-tier is the “glue” that connects the front-end and the back-end, although it would be understood by those of skill in the art that the front-end and back-end do communicate directly for some system functions. It should also be understood by those of skill in the art that the terms “front-end”, “mid-tier” and “back-end” are used herein for ease of explaining the present invention, and different functions may be performed in different areas of the system without departing for the spirit and scope of the invention. For example, a function described herein may be described as being implemented by the front-end, but this function may be implemented by the mid-tier or the back-end.

In general, the terminology “mid-tier” is being utilized for convenience to explain that that this entity receives a user query from the front-end and may translate this to a query script that the back-end can understand and execute. As an example, the user in the front-end may type the keyword “magnetic device” and initiate a search for patents containing this term in their titles. The mid-tier takes this input and converts this into a Structured Query Language (SQL) script such as: SELECT * FROM uspto_patent_grant WHERE invention_title=‘magnetic device’.

Translating user queries into scripts that can be executed in the database may be one of the functions of the mid-tier. It may also translate user preferences to scripts and commands that the back-end can interpret. One such user preference is the fields that the user wants to output when viewing the results of a query. For instance, the user may search for the term ‘magnetic field’ as in the example above, and may want to display the patent number, title, and assignee of the patents that are found. Alternatively, the user may choose to display many other fields about the patents when downloading the results in a file. Mid-tier translates these requirements to appropriate parameters for the back-end to take and interpret.

Another example function of the mid-tier is the formatting and translating of the results from the back-end for displaying in the front-end. For instance, the filing date of a patent may be stored in an RDBS field as “10081998,” which the mid-tier reads and translates to “1998, October 8^{th}” to make it understandable easily by the user viewing it through the front-end.

Another example function of the mid-tier is to respond to user requests by retrieving and delivering to the front-end files such as patent figures, tables, and lists, and PDF copy of the patent, among other things. The mid-tier facilitates retrieving from the back-end and delivering to front-end the PDF copy of the file, sending this to a printer, saving user queries, saving user files, formatting patent figures to fit into the space provided in the front-end for displaying them, and other functions that may not be performed by the front-end or by the back-end.

The following section describes some functions and features embedded in example web pages in the example implementation of the system. Functions of the front-end, mid-tier, and back-end will be further described through the explanations in the following section.

This section describes the functions and features of the system, especially as viewed and as experienced by the user. To describe the functions and features, reference is made to the example implementation of the system shown in FIG. 4 through FIG. 12. It should be understood that this is not intended to limit the inventions to the example implementation, but to make it easier to explain them. Current example implementations are only one of the many ways to build the inventions disclosed herein.

The search query interface has two primary search options. One is the Basic Search where a query can be entered in a simple form and triggers a full text search over all patent documents in the database. In the example implementation, the default time period for the full text search is set to be the year 1990 and later, although a user can change that in the settings. The Basic Search syntax may include the following basic rules.

One basic rule may be that keywords separated by spaces are treated as having AND in place of the space. For instance a search for [magnetic device] looks for presence of [magnetic] AND [device] in the full text of patents. For a successful match, both words [magnetic] and [device] must be present.

Another basic rule may be that keywords separated by commas are treated as having OR in place of the comma. For instance a search for [magnetic, device] will find patents whose text includes either [magnetic] OR [device] keywords in it. For a successful match either or both of the words [magnetic] and [device] must be present.

Another basic rule may be that keywords in quotation marks search for an exact match. For instance the search [“magnetic device”] will look for presence of exact match to the term “magnetic device.”

Basic Search lets the user enter the query in the search box 420 shown in FIG. 4 in the front-end. Then the mid-tier may receive the query and convert that to a script that the RDBS can understand and execute as explained earlier. It is the mid-tier that may also interprets the query syntax according to the rules above. Once the query script—with the appropriate AND or OR substitutions—is created, may be sent to the back-end for processing and executed as a search script in the RDBS.

The second search query option is the Advanced Search, where the user can enter a more detailed search and specify which fields should be searched for which keywords, as in FIG. 5. For instance, the user can specify that the Title 510 of the patent should (or should not) have one or more keywords, and say the inventor name 520 should include a keyword, and additionally the search should be limited to patents within a date range 530. A user can add additional criteria to the Advanced Search or remove some of the criteria, optionally, as seen in FIG. 5, by clicking “Add more criteria” 540 or by clicking “x” 550 to the right of the input boxes, respectively.

In the Advanced Search option, the syntax for each field may have the same rules as those listed above for the Basic Search. Once the query is entered in the front-end and the user clicks “Search” 560 to trigger the search, the mid-tier may take the query and converts it to a search scripts that the RDBS can understand, similar to the case described above for the Basic Search option.

Once the mid-tier translates the user query into a script that can be executed in the back-end and the results of the query are generated, the mid-tier then may take the results, format them for viewing in the front-end, and pass them to the front-end for presenting to the user. An example of the results being displayed in the front-end is shown in FIG. 6, FIG. 7 and FIG. 12. These Figures show the three different ways of viewing the results.

FIG. 6 illustrates an example List View where the results are presented in a list 600, such as a table, showing the Publication (Patent) Number 610 and other fields selected by the user for displaying, such as the Title 620, Assignee 630, and others. Default fields for displaying may be the Publication (Patent) Number 610, Title 620, Assignee 630, Inventor 640, Date 650, and US Class 660. In this List View, the user can sort the list 600 by any of the columns either in ascending or descending order. In the example implementation of the system, clicking the Publication (Patent) Number, for example, “7921157” 670, opens up a new window for reviewing the details of a patent, and clicking any part of a record other than the Publication (Patent) Number, (for example, the Inventor, such as “Scott K. Brown” 645) opens up the Preview Pane for that patent. Toward the top right of the screen in List View, and in other views of the Results Page, such as FIG. 7, and FIG. 12, four action buttons (or icons) indicate the type of view of Results Page being displayed. From left to right, the four action buttons correspond to the List View 682 (default results page, as shown in FIG. 6, with the List View button depressed (or highlighted)), Preview Panes View 684 (which opens all of the preview panes at once, instead of the user clicking and opening individual preview panes, and is not shown the Figures), Gallery View 686 (shown in FIG. 12), and the TrueValue page 688 (shown in FIG. 11). The user may switch between and among the List View, Preview Panes View, and Gallery View by clicking the appropriate action button (icon). Pressing the fourth icon 688 (the TrueValue icon) takes the user to the TrueValue page (shown in FIG. 11).

FIG. 7 illustrates an example Preview Pane displayed in a List View. The Preview Pane is a second Results view and is an extension of the view in FIG. 6. The Preview Pane 700 may contain the basic bibliographic information about a patent such as the Inventor(s) 730, Assignee 740, Date 750, and Abstract 760, in addition to the Patent number 710 and Title 720. The Preview Pane 700 may also display the first of the patent FIG. 770. This is usually the primary figure that appears on the front page of the patent. Users can also click the appropriate buttons shown in FIG. 7 to download a PDF copy of the patent 780 or to print the patent 785. In addition to the functions shown explicitly in FIG. 7, another function enables a user to print the Preview Pane contents of all the patents in the Results set automatically, for later reviewing. Alternatively, the user can print the Preview Pane for only one patent (as explained above) or for the patents that are selected by clicking the selection boxes 790 to the left of each record in FIG. 7. As an alternative to printing, the user can output the same information as a PDF file for later reviewing and printing. At the top of the page shown in FIG. 7, the user can click the Preview Panes View action button 786 to display Preview Panes for all patents or close all the Preview Panes for all the patent documents displayed (as indicated above, the Preview Panes View page is not shown in the Figures).

FIG. 12 illustrates an example Gallery View. The Gallery View is a third Results view. In the Gallery View, the patent figure is given prominence over some of the other details of the patent such as the Abstract. This Gallery View is especially suited for reviewing design patents since the patent figure is the key part of a design patent. In the Gallery View such as what's shown in FIG. 12, a user can click the Patent Number (e.g., “8281017” 1210) and open a new display to see the details of the patent, or click the arrows 1220 to display other figures of the patent.

Detailed patent reviews are essential for accurate evaluation of patents. By their nature, patents are complicated documents and their scope and applicability to specific products may be dependent on details that are not easily recognized without a detailed review. In a detailed review, one needs to read the description carefully, identify specific terms, correlate the descriptions with the figures in the table, and be able to search for keywords within the description, among other things. The system and method disclosed herein include a specific interface that includes all of that functionality and makes detailed patent reviews easy, quick, and intuitive.

FIG. 8, FIG. 9, and FIG. 10 show example views of the Detailed Review Page. FIG. 8 illustrates an example Detailed Review Page highlighting the Abstract section 810. FIG. 9 illustrates an example Detailed Review Page highlighting the Claims section 910. FIG. 10 illustrates an example Detailed Review Page highlighting the Description section 1010. In one example implementation, the user accesses the Detailed Review Page from the Results Page by clicking on the Patent number (or Publication number). Upon clicking the Patent number in the front-end, the mid-tier recognizes the patent number and issues a request to the back-end to provide the details of that patent. The back-end pulls the information from the RDBS and from the file system, and provides the information to the mid-tier. Then the mid-tier formats the information and passes it to the front-end for displaying. In other implementations, there may be other ways to get to the same page as well. The Detailed Review Page has a number of innovative features and functions. An important aspect of this page is the ability to review the description text of the patent and the figures in the patent side by side. Typically in a patent, the patent description text references the figures in the patent in explaining the inventions. One needs to view the figures in light of the accompanying text within the description. However the figures in a patent are placed all together—typically up front—and the description text comes after. This makes it difficult for a reviewer to keep going back and forth between the figures and associated text. The system and method disclosed herein address this difficulty by displaying the description text and the figures side by side as in FIG. 8, FIG. 9, and FIG. 10.

There are two features in Detailed Review Page that help make this side by side review of description text and figures intuitive and easy. One such feature is automatic selection of the figure that relates to the text being reviewed. For example, when the user is reviewing the description text and the text references a particular figure in the patent, that figure is identified and retrieved from the back-end, and then displayed alongside the text. In this scenario, the mid-tier monitors the text being sent to the front-end for displaying and detects the presence of keywords such as Figure X. Upon detecting the keyword, the mid-tier requests the corresponding figure from the back-end. The figure is pulled out from the RDBS or the file system and passed to the front-end—after formatting, if necessary—for displaying. A second feature is similar such that when the user selects one of the figures and displays it on the Detailed Review Page, the system brings up the part of the text that refers to that figure and displays it alongside the figure. FIG. 8, FIG. 9, and FIG. 10 show this scenario as well. In this scenario, the mid-tier recognizes the figure number and searches for the part of text that references it. The mid-tier then retrieves that part of the text from the back-end and passes it to the front-end. The two features described above are user selectable, and it is also possible to disable the two options at the user's discretion.

In addition to the automatic paring of the associated text and the figure, there are other useful features within the Detailed Review Page. One such useful feature is that the user can enter a keyword or key phrase in the search box at the bottom of the screen 1020 and have every instance of that keyword highlighted within the patent description text. In one example implementation, the system does this using Javascript in the front-end but other methods are possible. Another such useful feature is that the menu bar on top of the screen is responsive to the section of the patent being displayed in the text section. For instance, not only can user can click the section of the patent in the menu and have text scroll to that section, but the user can do the opposite; the user can scroll up or down in the text section of the screen and the menu automatically highlights the section title on the menu bar. This is also a function of the front-end, and it is implemented using Javascript in the example implementation.

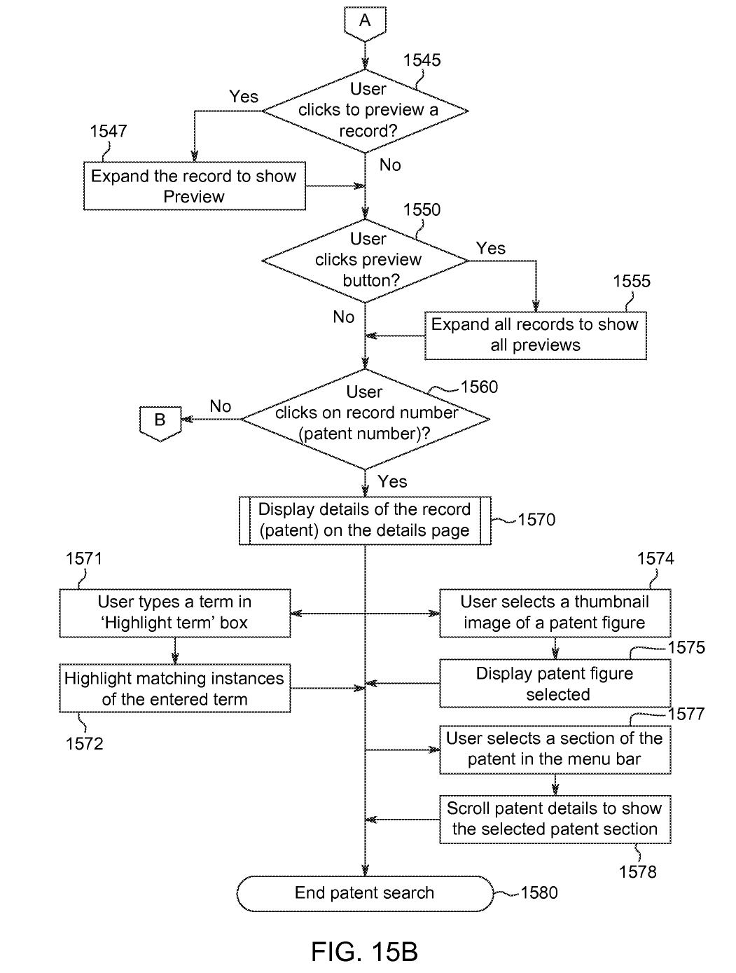

FIGS. 15A-15B illustrate an example method of using the system to search for and display patents and patent related information. The user starts the patent search process 1501 and decides if they prefer a Basic Search or an Advanced Search 1505. The user then may navigate to the Basic Search or Advanced Search page, accordingly. Under Basic Search, the user may enter the desired search string 1510 and click “Search” 1530 to active the search function. Under Advanced Search, the user may select search criterion from one or more pull-down lists 1520 and enter the corresponding search string(s) for the selected search criterion 1522. If the user desires to add additional criteria 1524, the user can click “Add more criteria” 1526. If not, the user may click “Search” 1530 to active the search function.

Upon receiving the search information, the SW and HW platform may search for patents meeting the entered query 1535. The platform then displays query results on a results page 1540. In reviewing the results, the user may scroll up or down 1542 or page ahead or backward 1543. The user may preview a patent 1545 (e.g., by clicking on any part of a record other than the Publication (or Patent) Number, as described in FIG. 6 and FIG. 7, above) and, further, may expand the record viewed to show the Preview 1547. If the user clicks the Preview Panes View action button (or icon) 1550, the platform expands all records to show all previews 1555. The user may return to the display of the query results 1540 or may click on the record number (Publication or Patent Number) 1560 to display the details of the record (Publication or Patent) 1570. When reviewing the patent details, the user may type a term in the “Highlight term” box 1571 to highlight matching instances of the entered term 1572. The user may also select a thumbnail of a patent FIG. 1574 for the platform to display the patent FIG. 1575. Further, the user may select a section of the patent in the menu bar 1577 for the platform to scroll the patent details to show the selected patent section 1578. The user may end the patent search 1580 and use other functions of the system.

The system and method described herein not only make it easy, quick, and intuitive to search and review patents but also enables the user to perform analytics based evaluation of the patents identified. Analytics based evaluation refers to the evaluation of patents based on bibliographic and other information, and is intended to supplement a subject matter expert (SME) review. In an SME review, the expert reads the patent and evaluates its use, coverage, strategic potential, and economic value based on that information. In an analytics based review, in contrast, there is no SME review needed, but one tries to assign a relative value to the patent based on bibliographic and other information. The information used in analytics based valuation may include things such as the number of claims, length of claims, priority date, length of prosecution, number of forward citations, number of backward citations, and many others. The expectation is that there is a correlation between these pieces of information and the actual economic value of the patent. There has been some research in academia and in industry to identify the right set of analytics information to use in such an evaluation and the right parameters to combine them. The system and method described herein does not prescribe a particular set of parameters to be used in all cases, and it does not assign a particular set of parameters as the optimum set for all portfolios. Instead, it creates a very innovative and useful tool for the user to conduct analytics based evaluation of patents easily, intuitively, and quickly using parameters that the user can specify.

General methods of doing analytics based evaluation of patents combines individual value indicators or parameters (or categories), which are the bibliographic and other information mentioned above, to create a value index for each patent. This value index is treated as an indication of the economic value of a patent—especially compared to other patents in the same portfolio. Combining herein means that the numerical value indicators or parameters are combined in a weighted average where the weights represent how much each value indicator contributes to the final value index. For instance, various examples of value indicators or parameters 1110 are shown in FIG. 11, such as Forw Cit 1111 (number of forward citation), Back Cit 1112 (number of backward citation), NonP Cit 1113 (number of non-patent citations), Priority 1114 (number of years since the priority date), claims 1115 (number of claims), Ind claims 1116 (number of independent claims), Clm Lght 1117 (length of claims, based on word count) and Family 1118 (number of patents that share the same priority) others. TrueValue 1120—the final value index—is a weighted average of these. In FIG. 11, eight value indicators or parameters 1110 are shown as an example, but there can be any number of value indicators or parameters 1110 being combined, including a single value indicator or parameter 1110. Other value indicators or parameters beyond those shown in FIG. 11 may also be used by the system and method. In an example implementation, the TrueValue 1120 is calculated as a weighted average as described above, however a TrueValue calculation can include multiplications of parameters, or other nonlinear functions of these parameters as well. A weighted average is provided as an example here for ease of describing the TrueValue concepts.

In one example, the system and method calculates all of the useful value indicators or parameters for each of the patents and stores them in the RDBS in the back-end. These values are displayed for each patent record as in FIG. 11. Value indicators or parameters can also be calculated in real time, in an alternative example implementation. When the user wants to perform analytics based valuation of patents, the user selects the value indicators or parameters (or categories), displayed as in FIG. 11, that should be included in the evaluation, and selects the weights for each of the value indicators or parameters. The selection of weights is done through the TrueValue command on top of the screen shown in FIG. 11 and others.

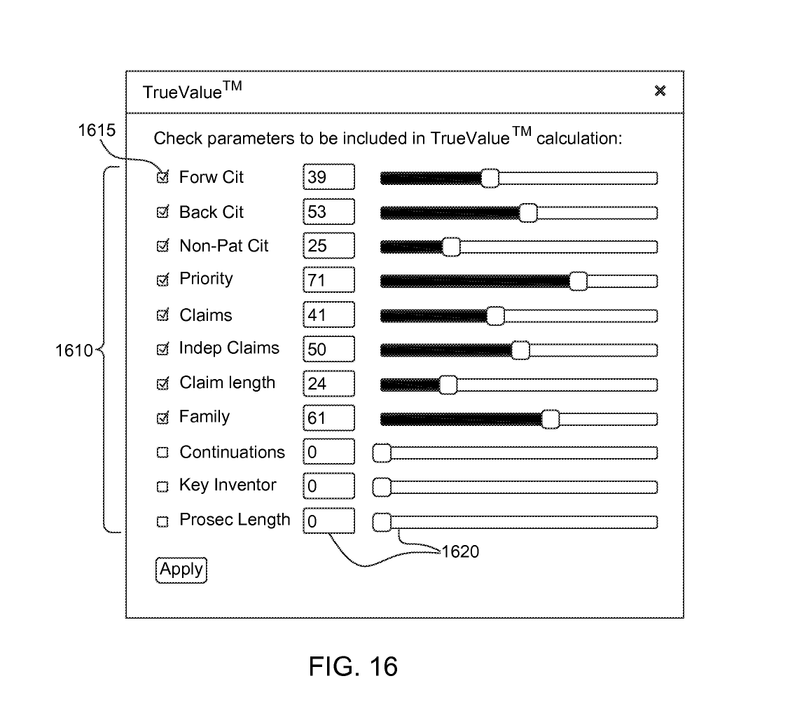

When the user clicks the TrueValue command, a dialog box is presented. FIG. 16 illustrates an example dialog box for TrueValue parameter or value indicator selection and weight setting. In FIG. 16, a number of parameters 1610 are presented to the user along with the ability to select 1615 each parameter for inclusion in the calculations and set the weight 1620 for each parameter. These weights 1620 are each applied to the individual parameters or value indicators 1610 in calculating the overall value index (or TrueValue score) for each patent. In effect, the TrueValue score may be calculated as:

TrueValue=Param1*Weight1+Param2*Weight2+ . . . +ParamN*WeightN Equation (1)

A user may experiment with different value indicators and varying weights such that a TrueValue index (or score) for each patent is calculated that is representative of the actual economic value of the patent.

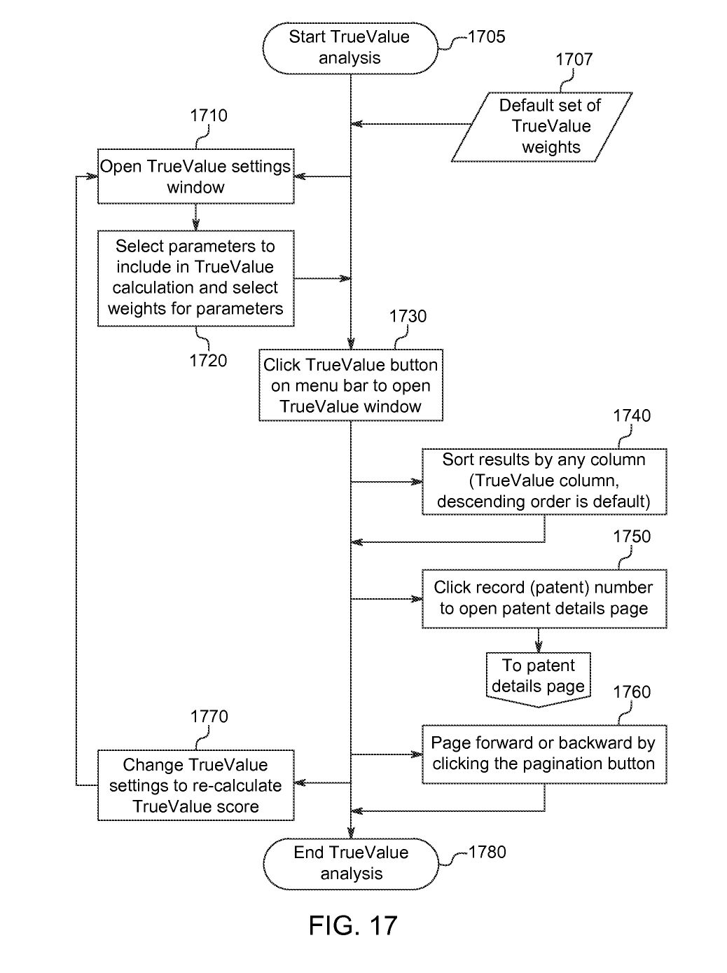

FIG. 17 illustrates an example method of using the system to calculate a TrueValue index or score. The user may start the TrueValue analysis 1705. The platform provides a default set of TrueValue weights 1707. The user may open the TrueValue settings window 1710 to select the parameters to include in the TrueValue calculation and the weights for those parameters, as seen in FIG. 16. The user may then click on the TrueValue button on a screen to open the TrueValue window 1730, as seen in FIG. 11. The user may sort the results by any column 1740, with the TrueValue score column presented in descending order by default. The user may then click on a record (Patent Number or Publication Number) to open the patent details page 1750. The user may also page forward or backward in the results by clicking the pagination button 1760. Further, the user may change the TrueValue settings 1770 and re-open the TrueValue settings window 1710. When complete, the user may end the TrueValue analysis 1780.

In general, the same set of parameters and weights may not apply to each portfolio or each patent equally well. The user may find the best set of parameters and weights by testing them in evaluating portfolios where the economic value is well understood. In effect, the user can do regression analysis to extract the suitable weights. Differences in patent prosecution strategy provide each portfolio a different composition and different bibliographic indicators. The system provides the user the ability to pick and choose the value indicators or parameters that are best suited for a particular portfolio, and the ability to adjust the weights for each value indicator or parameter. This is the first time a tool such as this has ever been built or offered to users who want to evaluate patents or patent applications.

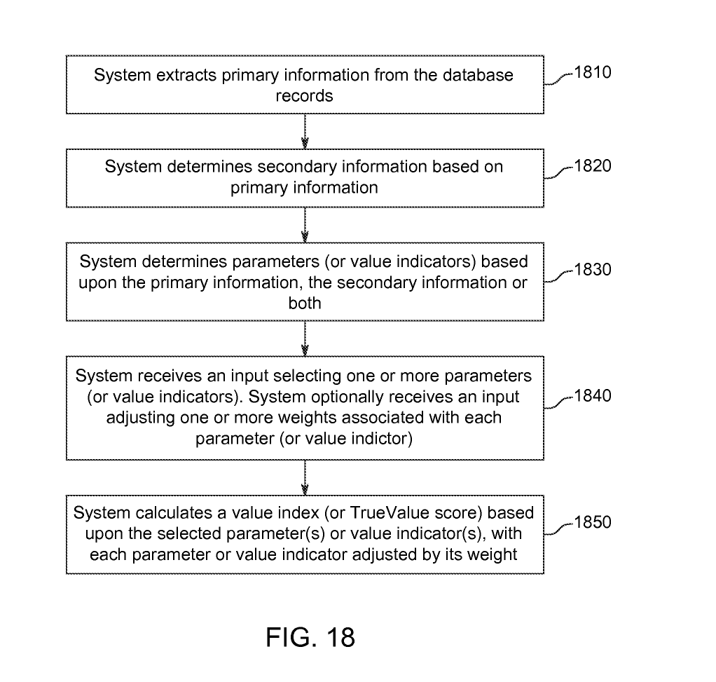

FIG. 18 illustrates an example method of the system calculating a TrueValue index or score. The system may extract primary information (such as a patent title, patent application number, patent number) from a database record (concerning a patent, patent application, reference, etc.) 1810. The system may then determine secondary information (such as number of claims, length of claims, forward citations, backward citations, etc.) based upon the primary information 1820. The system may then determine parameters (or value indicators) based upon the primary information, the secondary information or both 1830. The system may then receive an input (from, e.g., the user) selecting one or more parameters (or value indicators) 1840. Also, depending upon the further inputs received, the system may adjust one or more weights associated with each parameter (or value indicator). The system may then calculate a value index (or TrueValue score) based upon the selected parameter(s) or value indicator(s), with each parameter or value indicator adjusted by its weight 1850.

The analytics based evaluation and SME review of select patents can work together to create a full evaluation. By performing analytics based valuation first, the user can identify the set of patents in a portfolio that are more likely to be valuable. Then SME review of this select set of patents can be done in a more time effective way to identify and confirm the most valuable patents.

The nature of patent analysis work is that the user typically needs to look at a portfolio from different perspectives, identify patents that fit certain criteria, create charts and lists to display intermediate results, and finally gather select pieces of intermediate work products and create a final report. There is no such tool or system in the market today that does that. The system and method described herein has a feature, referred to as Projects or Side Pocket, that solves this problem.

Projects (or Side Pocket) is a temporary work space where different types of work output can be saved during portfolio evaluation. By way of example, a user may be looking for patents in a particular topic. The user can enter the appropriate keywords and other constraints on the Search screen shown in FIG. 4 and FIG. 5, click Search, and get a resultant set of patents presented on the Results screen shown in FIG. 6 and FIG. 7. The user may now plot charts showing the number of patents for top inventors or top assignees, or the user can plot charts showing the distribution of filing dates of patents in the results set by years, or their distribution by U.S. Class codes. The user may generate these and other charts using the functions in example functions that are explained further below. A user can save these charts in the Side Pocket by clicking the “Save to Projects” (or “Save to Side Pocket”) command next to the chart (not shown in the Figures) or by right clicking on a chart or figure and selecting the “Save to Projects” (or “Save to Side Pocket”) command. In this manner the user can generate multiple charts and lists as the user works on a project. Project (or Side Pocket) contents may be automatically updated by the system and method, and can be viewed by the user by clicking “Projects” command on the top menu of the screen seen in FIG. 11 and others.

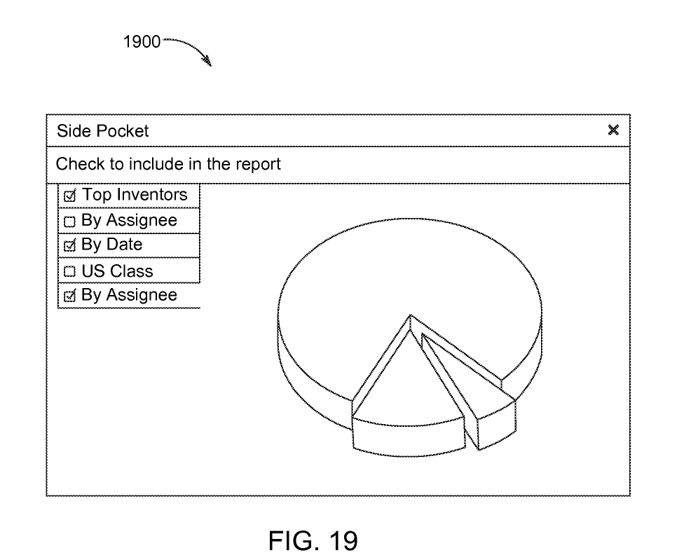

FIG. 19 illustrates an example view of the Side Pocket (or Projects) contents. When the user is satisfied that the useful and relevant charts 1900, figures and lists are created and ready for reporting, then the user clicks “Save Report” (not shows in the Figures) and the system and method automatically creates a PDF report containing the Side Pocket (or Projects) contents and outputs it in PDF format.

Side Pocket (or Projects) can be used to temporarily store charts, figures, lists, queries, notes, and annotations. The user can then select which of these intermediate work products should be included in a report, and then create a PDF (or other document format) report automatically. In an example, the mid-tier queries the front-end and receives the list of charts, lists, etc. to be output in the report. Then the mid-tier may use an appropriate library function to convert each of these and wrap them in a PDF envelope. Thus a PDF file with all selected Side Pocket content can be created.

In an example, many views, commands, and functions can be customized by the user. The customization options may be presented to the user in the User menu, in the Settings menu, or in the Preferences menu, among other places. These customization options are numerous. Some examples are given in the following example list: which fields of each patent to show in the Results Page; which fields of each patent to output in an output file; which file format to use when saving, downloading data, charts, and results; which columns to use for sorting results; value of parameters (weights) in TrueValue calculations; x-axis and y-axis data when creating charts; which lists to create (top inventors, top assignees, and others); filter parameters when filtering a result set (further constraints on Title, Inventor, Assignee, and other fields); and others.

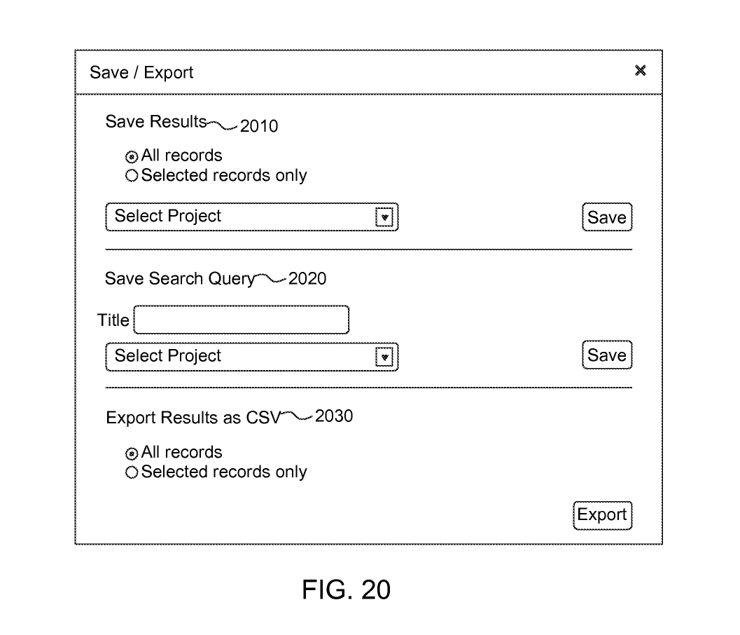

In addition to the functions outlined so far, an example function gives the user the ability to save queries and results. This may be done by selecting the appropriate options, such as by clicking the Save command at the top of the screen as shown in FIG. 6, FIG. 7 and others. FIG. 20 illustrates an example of the Save Window that opens up when the user clicks the Save command. Here the user can, among other things, save the search results 2010, save the search query 2020 or export the results as a CVS file 2030.

In creating the charts, the mid-tier may receive the user selection such as the x-axis and y-axis data sets, and chart type, from the front-end. Then the mid-tier requests and receives the data needed from the RDBS. Finally the mid-tier may create the chart or list requested by the user and deliver it to front-end for displaying. In an example, the charts can be created in the front-end as well, using, for instance, Javascript.

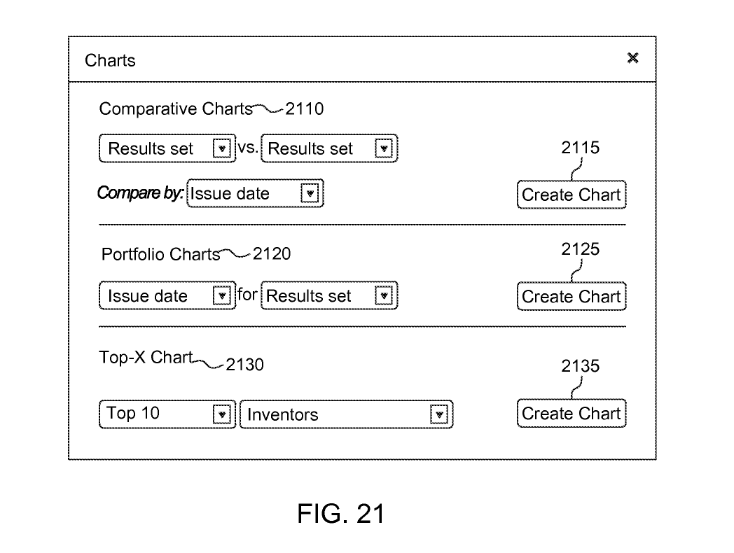

FIG. 21 illustrates an example of the Chart Window that opens up when the user clicks the Chart command. This may be done by selecting the appropriate options, such as by clicking the Chart command at the top of the screen as shown in FIG. 6, FIG. 7 and others. In this window, the user can select the x-axis and y-axis of charts, chart type (not shown), and also time period to include. The user can use Comparative Charts 2110 to compare result sets and Portfolio Charts 2120 to create charts for a portfolio of patents. In the same window, the user can select from the drop-down boxes under “Top-X Chart” 2130 to create lists showing the top inventors, top assignees, top US Classes, and others. After the user has prepared the settings for the chart type desired, the user then hits the corresponding “Create Chart” button 2115, 2125 or 2135.

Although features and elements are described herein in particular combinations, each feature or element can be used alone or in any combination with or without the other features and elements. For example, each feature or element as described above with reference to any Figure or any combination of Figures may be used alone without the other features and elements or in various combinations with or without other features and elements. Sub-elements and/or sub-steps of the methods described herein with reference to any Figure or any combination of Figures may be performed in any arbitrary order (including concurrently), in any combination or sub-combination.

What is claimed is:

1. A computer based method for determining a value index for a database record, the method comprising:
extracting, by a processor, one or more primary information fields to obtain primary information associated with one or more of the database records;
storing, by a computer memory, the primary information;
determining, by the processor, secondary information fields associated with the one or more database records, wherein the secondary information is based at least in part on the primary information;
storing, by the computer memory, the secondary information;
determining, by the processor, one or more value indicators associated with the one or more database records, based upon the primary information field or the secondary information field or both;
setting, by the processor, a weight for each value indicator to a default value;
receiving, by the processor, an input selecting one or more value indicators;
adjusting, by the processor, one or more weights on a condition that an input for weight adjustment is received by the processor; and
calculating, by the processor, the value index based on the selected value indicators, wherein each value indicator is adjusted based on the weight for the value indicator.

2. The method of claim 1, wherein the database record is one or more of a patent, patent application, patent publication or patent-related reference.

3. The method of claim 1, further comprising reading, by the processor, a data file to create one or more database records.

4. The method of claim 3, wherein the date file is extracted from an external data source.

5. The method of claim 3, wherein the data file is a patent data file.

6. The method of claim 4, wherein the data file is a patent data file and the external data source is a patent database of a patent office.

7. The method of claim 1, wherein a database record corresponds to an asset.

8. The method of claim 2, further comprising displaying the value index for one or more patents.

9. The method of claim 8, further comprising displaying the value indicators for one or more patents.

10. The method of claim 2, further comprising compiling one or more patents into a portfolio.

11. The method of claim 2, further comprising providing a recommendation to make a transaction concerning a patent on a condition that the value index of the patent exceeds a threshold.

12. The method of claim 2, further comprising completing a transaction concerning a patent on a condition that the value index of the patent exceeds a threshold.

13. The method of claim 1, where in the inputs are received and the value index is calculated using one or more of a front-end part, mid-tier part and back-end part.

14. A computer based method for reviewing database records concerning patents and patent applications, the method comprising:
receiving, by a processor, an input selecting one or more database records;
displaying information from the selected database records;
receiving, by a processor, an input selecting a section of a database record; and
displaying information from the selected section of the database record.

15. The method of claim 14 further comprising displaying, at one time, information from a plurality of selected sections of a database records.

16. The method of claim 14 further comprising displaying, at one time, information from a plurality of selected sections of a plurality of database records.

17. The method of claim 15 wherein at least one of selected sections is a text portion of a description of a patent or patent application and at least another of the selected sections is a patent figure, of the patent or patent application, that corresponds to the text portion.

18. The method of claim 14, where in the inputs are received and the information is displayed using one or more of a front-end part, mid-tier part and back-end part.
